(19) United States
(12) Patent Application Publication
(10) Pub. No.: US 2019/0373474 A1
(43) Pub. Date: Dec. 5, 2019

(54) Detection Of Rogue Cells In 5G Mobile Communications

(71) Applicant: MediaTek Singapore Pte. Ltd., Singapore (SG)

(72) Inventors: Matti Moisanen, Oulu (FI); Marko Niemi, Oulu (FI)

(21) Appl. No.: 16/424,755

(22) Filed: May 29, 2019

Related U.S. Application Data
(60) Provisional application No. 62/677,322, filed on May 29, 2018.

(51) Int. Cl. H04W 12/12; H04L 9/32

(52) U.S. Cl. CPC H04W 12/1202; H04L 9/3236

(57) ABSTRACT

Examples pertaining to detection of rogue cells in 5G mobile communications are described. A processor of an apparatus generates at least a part of a request, using a concealment function, and transmits the request to a communication entity. The processor then receives a response message from the communication entity. The processor determines, based on a parameter in the response message, whether the communication entity is a network node of a genuine Public Land Mobile Network (PLMN) or a rogue cell faking to be genuine.

### CROSS REFERENCE TO RELATED PATENT APPLICATION(S)

The present disclosure is part of a non-provisional application claiming the priority benefit of U.S. Patent Application No. 62/677,322, filed on 29 May 2018. The content of aforementioned application is herein incorporated by reference in its entirety.

### TECHNICAL FIELD

The present disclosure is generally related to mobile communications and, more particularly, to detection of rogue cells in 5^{th} Generation (5G) mobile communications.

### BACKGROUND

Unless otherwise indicated herein, approaches described in this section are not prior art to the claims listed below and are not admitted as prior art by inclusion in this section.

In a 5G System (5GS), integrity protection of non-access stratum (NAS) messages is applied to achieve secure and reliable signaling between a user equipment (UE) and an Access and Mobility management Function (AMF). Additionally, in 5GS, subscriber identity (e.g., Subscription Permanent Identifier (SUPI)) can be protected by cryptographically concealing the subscriber identity using public key cryptography and information provisioned to a Universal Subscriber Identity Module (USIM) by an operator. The concealment can be used also if the subscription is closed.

There may be situations in which an intruder sets up a malicious fake cell that pretends to be part of a real Public Land Mobile Network (PLMN) and sends registration reject causes to UEs without integrity protection. Such reject causes may invalid the USIM in the UE or prevent the UE from obtaining service otherwise. Such vulnerability is possible because the UE has no means to detect whether the protection is absent because the subscription is really invalid (e.g., whether the reject is received from a genuine PLMN or from a fake rogue cell). An approach to address such an issue, which has been specified for Evolved Packet System (EPS) and Universal Mobile Telecommunications System (UMTS), allows a UE to attempt registration several times in several cells or networks before finally concluding that the USIM in the UE is invalid. However, such approach is still not sufficient to address the issue especially in cases where there is only one cell available.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of an apparatus generating at least a part of a request, using a concealment function, and transmitting the request to a communication entity. The method may also involve the processor receiving a response message from the communication entity. The method may further involve the processor determining, based on a parameter in the response message, whether the communication entity is a network node of a genuine Public Land Mobile Network (PLMN) or a rogue cell faking to be genuine.

In one aspect, a method may involve a processor of an apparatus generating a first hash value and a request. The method may also involve the processor transmitting the request to a communication entity. The method may further involve the processor receiving a response message from the communication entity. The method may additionally involve the processor determining, based on a second hash value in the response message, whether the communication entity is a network node of a genuine PLMN or a rogue cell faking to be genuine.

In one aspect, a method may involve a processor of an apparatus transmitting a request to a communication entity. The method may also involve the processor receiving a response message from the communication entity. The method may further involve the processor determining, based on the response message, whether the communication entity is a network node of a genuine PLMN or a rogue cell faking to be genuine. In determining, the method may involve the processor determining by a first procedure, using a concealment function, or a second procedure, using a hash value.

It is noteworthy that, although description provided herein may be in the context of certain radio access technologies, networks and network topologies such as New Radio (NR) or non-3GPP access in 5G system, the proposed concepts, schemes and any variation(s)/derivative(s) thereof may be implemented in, for and by other types of radio access technologies, networks and network topologies such as, for example and without limitation, EPS, UMTS, Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

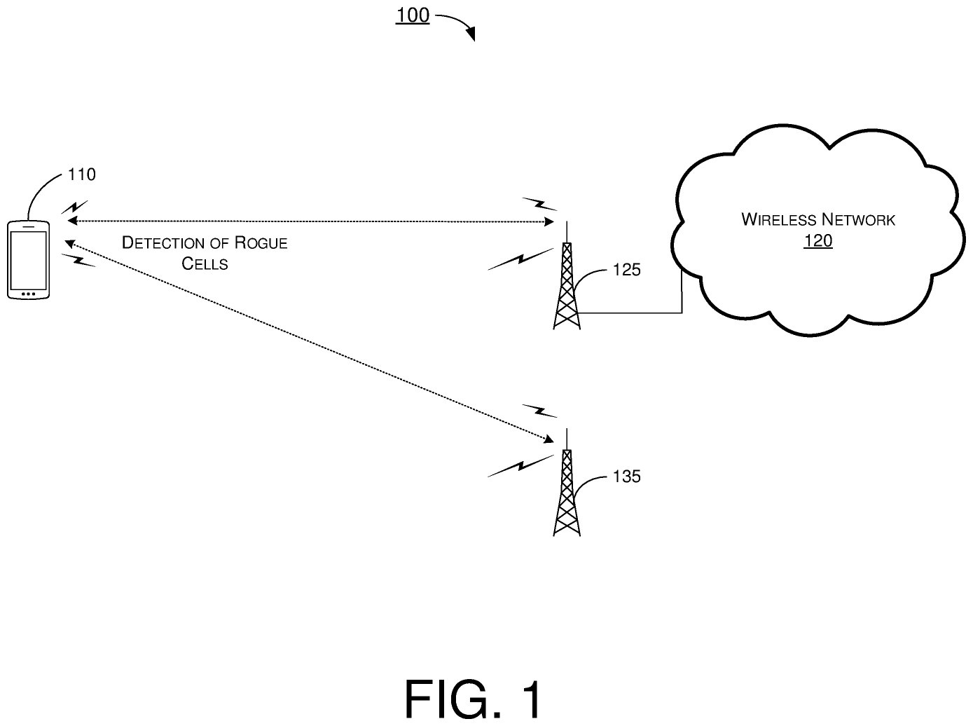

FIG. 1 illustrates an example network environment 100 in which various solutions and schemes in accordance with the present disclosure may be implemented. Referring to FIG. 1, network environment 100 may involve a user equipment (UE) 110 attempting to establish wireless communication with a wireless network 120 (e.g., a 5G NR mobile network) via a base station 125 (e.g., a gNB or transmit-receive point (TRP)) and a rogue cell 135, which may be a rogue cell faking to be genuine. In network environment 100, UE 110 may implement various schemes pertaining to detection of rogue cells in 5G mobile communications in accordance with the present disclosure. For instance, UE 110 may transmit a request to base station 125 and/or rogue cell 135 and, in response, receive a response message from base station 125 and/or rogue cell 135. Accordingly, UE 110 may determine whether base station 125 and/or rogue cell 135 is a network node of a genuine PLMN (e.g., network 120) or a rogue cell faking to be genuine. The follow description of various solutions in accordance with the present disclosure is provided with reference to FIG. 1.

Under a first proposed scheme in accordance with the present disclosure, a subscription identifier concealment function may be used to confirm that a reject cause received by a UE is from a real/genuine network. Under the proposed scheme, information in a request sent by the UE may be concealed and the network may respond with a parameter which is available only if the concealment has been de-concealed correctly by the network.

In one example implementation of the proposed scheme, the UE may send UE identity (e.g., International Mobile Subscriber Identity (IMSI)) in a concealed format (e.g., as a Subscription Concealed Identifier (SUCI)). The home PLMN may de-conceal the SUPI even if the subscription is closed and the IMSI is unknown in the network. In such cases the network may send the de-concealed IMSI back to the UE together with a reject cause. The UE may compare its stored IMSI and the received IMSI and, if the IMSI was de-concealed correctly, deem that the network reliable and, thus, behave according to the reject cause. It is noteworthy that there may be a security concern with the IMSI being sent in plain text. However, if the reason for the network to send a response message is that the subscription is not valid anymore (e.g., invalid UE), then the IMSI should not be confidential information in such cases.

In another example implementation of the proposed scheme, the UE may send only a part of de-concealed data (e.g., a portion of the IMSI). In such cases, the entire IMSI is not revealed yet the UE may still reliably detect whether de-concealing was performed correctly. The response data may be selected randomly so that the UE may compare and determine whether at least a given number of octets of the replied IMSI are correct to deem the response genuine.

In yet another example implementation of the proposed scheme, one or more other parameters in the request may be concealed and then de-concealed. For instance, a random piece of data that the UE stores may be used to compare with a response from the network. Additionally, the response itself, or a portion of it, may be concealed and the UE may de-conceal the response (or the concealed portion thereof) using a concealment function/algorithm.

It is noteworthy that, under the proposed scheme, a request message from the UE would contain the UE identity which may be used for the purpose of the proposed scheme. Thus, in an event that there is some other new data to be applied, such data may be added to the request message. Similarly, response information from the network may be added in a response message.

Under a second proposed scheme in accordance with the present disclosure, a SUCI concealment function may be used to create a hash value over a protocol data unit (PDU) of a request. Under the proposed scheme, the UE may store the created hash value locally and, upon receiving a response (e.g., response message) from the network which contains a hash value, compare the received hash value with the stored hash value to determine whether the network is genuine, and hence reliable, based on whether the received hash value and the stored hash value are equal to each other.

In one example implementation of the proposed scheme, the UE may calculate a hash value over a PDU, or a portion thereof, of a submitted request, or over a local SUPI value, using one or more parameters and/or algorithms of the SUCI concealment function and store the calculated hash value. In rejecting the request, the network may calculate a corresponding hash value and include it in the response message. The UE may then compare the received hash value with its stored hash value to see if they are equal and, in an event that they are equal, deem the network reliable and behave according to the reject cause.

### Illustrative Implementations

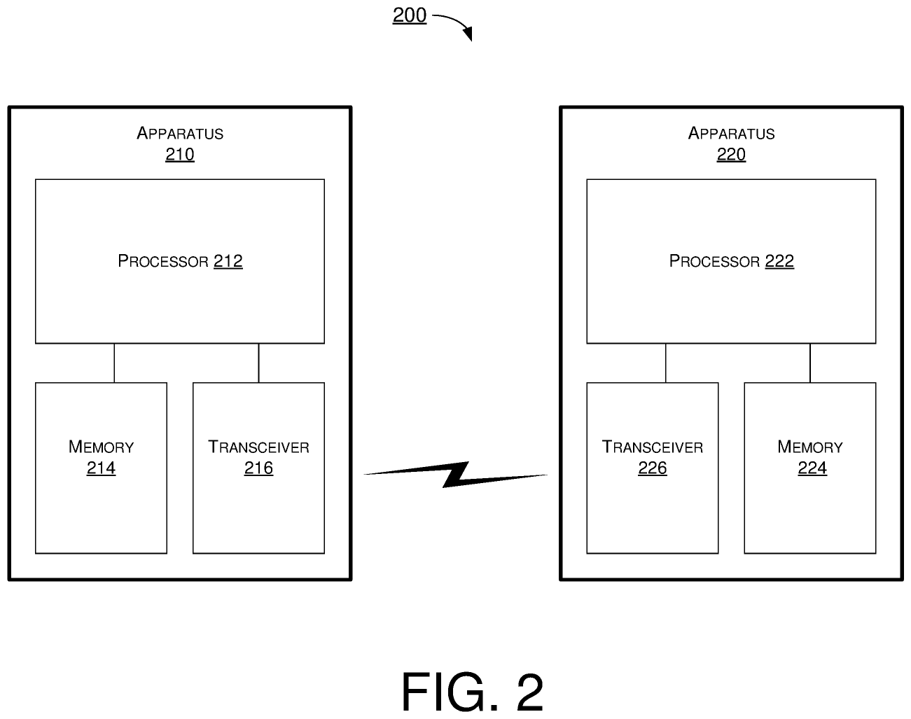

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to detection of rogue cells in 5G mobile communications, including the various schemes described above with respect to various proposed designs, concepts, schemes, systems and methods described above, including network environment 100, as well as processes 300, 400 and 500 described below.

Each of apparatus 210 and apparatus 220 may be a part of an electronic apparatus, which may be a network apparatus or a UE (e.g., UE 110), such as a portable or mobile apparatus, a wearable apparatus, a wireless communication apparatus or a computing apparatus. For instance, each of apparatus 210 and apparatus 220 may be implemented in a smartphone, a smart watch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to detection of rogue cells in 5G mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE, and apparatus 220, as a base station of a serving cell of a wireless network (e.g., 5G/NR mobile network), is provided below. It is noteworthy that, although the example implementations described below are provided in the context of a UE, the same may be implemented in and performed by a base station. Thus, although the following description of example implementations pertains to apparatus 210 as a UE (e.g., UE 110), the same is also applicable to apparatus 220 as a network node or base station such as a gNB, TRP or eNodeB (e.g., network node 125) of a wireless network (e.g., wireless network 120) such as a 5G NR mobile network.

In one aspect, under a proposed scheme in accordance with the present disclosure, processor 212 of apparatus 210 may generate at least a part of a request using a concealment function. Additionally, processor 212 may transmit, via transceiver 216, the request to a communication entity (e.g., apparatus 220). Moreover, processor 212 may receive, via transceiver 216, a response message from the communication entity. Furthermore, processor 212 may determine, based on a parameter in the response message, whether the communication entity is a network node of a genuine PLMN or a rogue cell faking to be genuine. Based on a result of the determining, processor 212 may behave according to a reject cause in the response message responsive to the communication entity being deemed genuine. Alternatively, processor 212 may ignore the response message responsive to the communication entity being deemed fake.

In some implementations, in generating the at least a part of the request using the concealment function, processor 212 may generate the request containing an identity of apparatus 210 in a concealed format using the concealment function.

In some implementations, in receiving the response message, processor 212 may receive the response message containing a de-concealed identity and optionally a reject cause. That is, in some cases, the response message may contain the de-concealed identity without the reject cause, and in some other cases, the response message may contain the de-concealed identity with the reject cause.

In some implementations, in determining based on the parameter in the response message, processor 212 may compare the de-concealed identity to the identity of apparatus 210 to determine that the communication entity is genuine responsive to the de-concealed identity being equal to the identity of apparatus 210 or that the communication entity is fake responsive to the de-concealed identity being different from the identity of apparatus 210.

In some implementations, in determining based on the parameter in the response message, processor 212 may perform several operations. For instance, processor 212 may identify a portion of the de-concealed identity. The identified portion of the de-concealed identity may be a random portion thereof or a specific/predefined portion thereof. Additionally, processor 212 may compare the portion of the de-concealed identity to a corresponding portion of the identity of apparatus 210 to determine that the communication entity is genuine responsive to the portion of the de-concealed identity being equal to the corresponding portion of the identity of apparatus 210 or that the communication entity is fake responsive to the portion of the de-concealed identity being different from the corresponding portion of the identity of apparatus 210.

In some implementations, in receiving the response message, processor 212 may receive the response message containing a portion of a de-concealed identity. In such cases, in determining based on the parameter in the response message, processor 212 may compare the portion of the de-concealed identity to a corresponding portion of the identity of apparatus 210 to determine that the communication entity is genuine responsive to the portion of the de-concealed identity being equal to the corresponding portion of the identity of apparatus 210 or that the communication entity is fake responsive to the portion of the de-concealed identity being different from the corresponding portion of the identity of apparatus 210.

In some implementations, in generating the request using the concealment function, processor 212 may further conceal a parameter or data using the concealment function such that the request contains the parameter or data in a concealed format. In such cases, in receiving the response message, processor 212 may receive the response message containing a de-concealed identity, a de-concealed data. Moreover, in determining based on the parameter in the response message, processor 212 may compare the de-concealed data, or a portion thereof, to the parameter or data sent in the request to determine that the communication entity is genuine responsive to the de-concealed data being equal to the data or parameter sent in the request or that the communication entity is fake responsive to the de-concealed data being different from the data or parameter sent in the request.

In some implementations, in receiving the response message, processor 212 may receive the response message such that at least one portion of the response message is concealed. In such cases, in determining based on the parameter in the response message, processor 212 may de-conceal, using the concealment function, the at least one portion of the response message that is concealed.

In another aspect, under a proposed scheme in accordance with the present disclosure, processor 212 may generate a first hash value and a request. Additionally, processor 212 may transmit, via transceiver 216, the request to a communication entity (e.g., apparatus 220). Moreover, processor 212 may receive, via transceiver 216, a response message from the communication entity. Furthermore, processor 212 may determine, based on a second hash value in the response message, whether the communication entity is a network node of a genuine PLMN or a rogue cell faking to be genuine. Based on a result of the determining, processor 212 may behave according to a reject cause in the response message responsive to the communication entity being deemed genuine. Alternatively, processor 212 may ignore the response message responsive to the communication entity being deemed fake.

In some implementations, in generating the first hash value, processor 212 may further compute the first hash value over at least a portion of a PDU of a request using a SUCI concealment function.

In some implementations, in generating the first hash value, processor 212 may compute the first hash value over a local SUPI value.

In some implementations, in generating the first hash value, processor 212 may compute the first hash value using a parameter, an algorithm or both the parameter and the algorithm of a SUCI concealment function.

In some implementations, in determining based on the second hash value in the response message, processor 212 may compare the first hash value and the second hash value to determine that the communication entity is genuine responsive to the second hash value being equal to the first hash value or that the communication entity is fake responsive to the second hash value being different from the first hash value.

In yet another aspect, under a proposed scheme in accordance with the present disclosure, processor 212 may transmit, via transceiver 216, a request to a communication entity (e.g., apparatus 220). Additionally, processor 212 may receive, via transceiver 216, a response message from the communication entity. Moreover, processor 212 may determine, based on the response message, whether the communication entity is a network node of a genuine PLMN or a rogue cell faking to be genuine. In some implementations, in determining, process 500 may involve processor 212 determining by a first procedure (as represented by 532) using a concealment function, or a second procedure (as represented by 534) using a hash value. Based on a result of the determining, processor 212 may behave according to a reject cause in the response message responsive to the communication entity being deemed genuine. Alternatively, processor 212 may ignore the response message responsive to the communication entity being deemed fake.

In determining by using the first procedure using the concealment function, processor 212 may perform various operations. For instance, processor 212 may generate the request such that the request contains an identity of apparatus 210 in a concealed format generated using the concealment function. Moreover, the response message may contain at least one portion of a de-concealed identity. Furthermore, in determining, processor 212 may compare the at least one portion of the de-concealed identity to at least one corresponding portion of the identity of apparatus 210 to determine that the communication entity is genuine responsive to the at least one portion of the de-concealed identity being equal to the at least one corresponding portion of the identity of apparatus 210 or that the communication entity is fake responsive to the at least one portion of the de-concealed identity being different from the at least one corresponding portion of the identity of apparatus 210.

In determining by using the second procedure using the hash value as a first hash value, processor 212 may perform various operations in generating the first hash value. For instance, processor 212 may compute the first hash value over at least a portion of a PDU of the request using a SUCI concealment function. Additionally, processor 212 may either compute the first hash value over a local SUPI value or compute the first hash value using a parameter, an algorithm or both the parameter and the algorithm of the SUCI concealment function. The response message may contain a second hash value. In such cases, in determining, processor 212 may compare the first hash value and the second hash value to determine that the communication entity is genuine responsive to the second hash value being equal to the first hash value or that the communication entity is fake responsive to the second hash value being different from the first hash value.

### Illustrative Processes

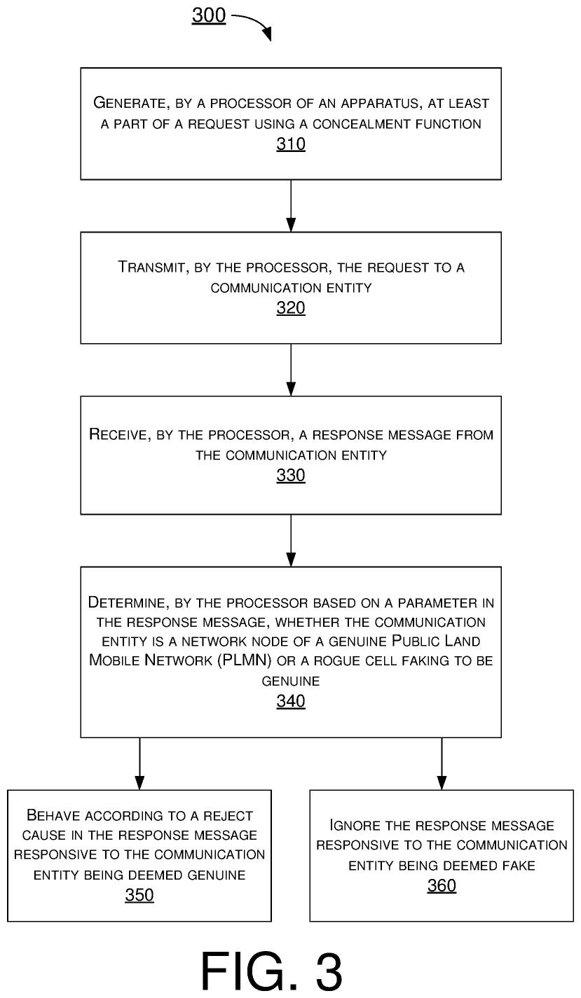

FIG. 3 illustrates an example process 300 in accordance with an implementation of the present disclosure. Process 300 may represent an aspect of implementing various proposed designs, concepts, schemes, systems and methods described above, whether partially or entirely, including network environment 100. More specifically, process 300 may represent an aspect of the proposed concepts and schemes pertaining to detection of rogue cells in 5G mobile communications. Process 300 may include one or more operations, actions, or functions as illustrated by one or more of blocks 310, 320, 330, 340, 350 and 360. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity, whether as a network node or base station (e.g., network node 125) of a genuine PLMN (e.g., wireless network 120) or rogue cell 135. Process 300 may begin at block 310.

At 310, process 300 may involve processor 212 of apparatus 210 generating at least a part of a request using a concealment function. Process 300 may proceed from 310 to 320.

At 320, process 300 may involve processor 212 transmitting, via transceiver 216, the request to a communication entity (e.g., apparatus 220). Process 300 may proceed from 320 to 330.

At 330, process 300 may involve processor 212 receiving, via transceiver 216, a response message from the communication entity. Process 300 may proceed from 330 to 340.

At 340, process 300 may involve processor 212 determining, based on a parameter in the response message, whether the communication entity is a network node of a genuine PLMN or a rogue cell faking to be genuine. Depending on a result of the determination, process 300 may proceed from 340 to 350 or 360.

At 350, process 300 may involve processor 212 behaving according to a reject cause in the response message responsive to the communication entity being deemed genuine.

At 360, process 300 may involve processor 212 ignoring the response message responsive to the communication entity being deemed fake.

In some implementations, in generating the at least a part of the request using the concealment function, process 300 may involve processor 212 generating the request containing an identity of apparatus 210 in a concealed format using the concealment function.

In some implementations, in receiving the response message, process 300 may involve processor 212 receiving the response message containing a de-concealed identity and optionally a reject cause.

In some implementations, in determining based on the parameter in the response message, process 300 may involve processor 212 comparing the de-concealed identity to the identity of apparatus 210 to determine that the communication entity is genuine responsive to the de-concealed identity being equal to the identity of apparatus 210 or that the communication entity is fake responsive to the de-concealed identity being different from the identity of apparatus 210.

In some implementations, in determining based on the parameter in the response message, process 300 may involve processor 212 performing several operations. For instance, process 300 may involve processor 212 identifying a portion of the de-concealed identity. Additionally, process 300 may involve processor 212 comparing the portion of the de-concealed identity to a corresponding portion of the identity of apparatus 210 to determine that the communication entity is genuine responsive to the portion of the de-concealed identity being equal to the corresponding portion of the identity of apparatus 210 or that the communication entity is fake responsive to the portion of the de-concealed identity being different from the corresponding portion of the identity of apparatus 210.

In some implementations, in receiving the response message, process 300 may involve processor 212 receiving the response message containing a portion of a de-concealed identity. In such cases, in determining based on the parameter in the response message, process 300 may involve processor 212 comparing the portion of the de-concealed identity to a corresponding portion of the identity of apparatus 210 to determine that the communication entity is genuine responsive to the portion of the de-concealed identity being equal to the corresponding portion of the identity of apparatus 210 or that the communication entity is fake responsive to the portion of the de-concealed identity being different from the corresponding portion of the identity of apparatus 210.

In some implementations, in generating the request using the concealment function, process 300 may further involve processor 212 concealing a parameter or data using the concealment function such that the request contains the parameter or data in a concealed format. In such cases, in receiving the response message, process 300 may involve processor 212 receiving the response message containing a de-concealed identity, a de-concealed data. Moreover, in determining based on the parameter in the response message, process 300 may involve processor 212 comparing the de-concealed data, or a portion thereof, to the data or parameter sent in the request to determine that the communication entity is genuine responsive to the de-concealed data being equal to the data or parameter sent in the request or that the communication entity is fake responsive to the de-concealed data being different from the data or parameter sent in the request.

In some implementations, in receiving the response message, process 300 may involve processor 212 receiving the response message such that at least one portion of the response message is concealed. In such cases, in determining based on the parameter in the response message, process 300 may involve processor 212 de-concealing, using the concealment function, the at least one portion of the response message that is concealed.

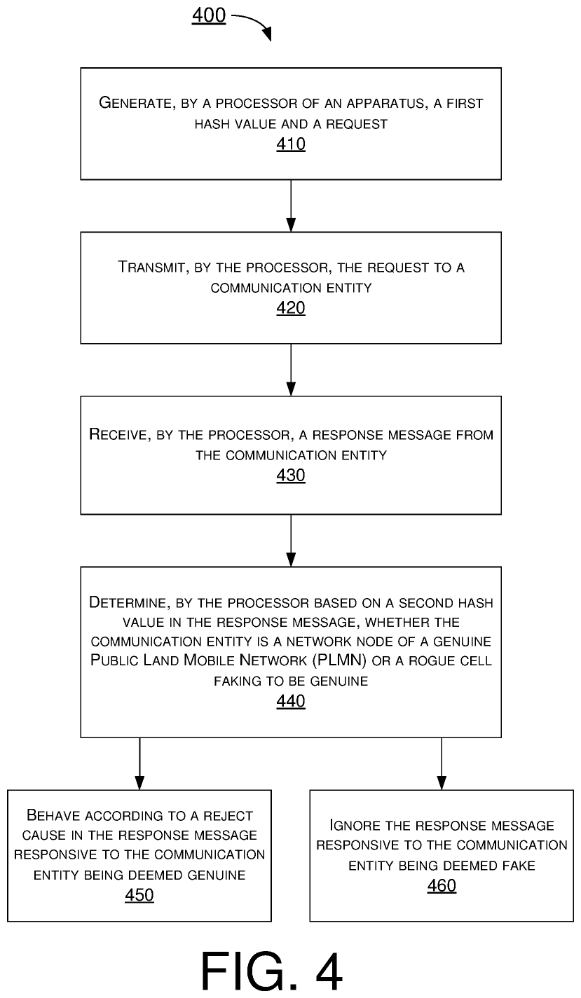

FIG. 4 illustrates an example process 400 in accordance with an implementation of the present disclosure. Process 400 may represent an aspect of implementing various proposed designs, concepts, schemes, systems and methods described above, whether partially or entirely, including network environment 100. More specifically, process 400 may represent an aspect of the proposed concepts and schemes pertaining to detection of rogue cells in 5G mobile communications. Process 400 may include one or more operations, actions, or functions as illustrated by one or more of blocks 410, 420, 430, 440, 450 and 460. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity, whether as a network node or base station (e.g., network node 125) of a genuine PLMN (e.g., wireless network 120) or rogue cell 135. Process 400 may begin at block 410.

At 410, process 400 may involve processor 212 of apparatus 210 generating a first hash value and a request. Process 400 may proceed from 410 to 420.

At 420, process 400 may involve processor 212 transmitting, via transceiver 216, the request to a communication entity (e.g., apparatus 220). Process 400 may proceed from 420 to 430.

At 430, process 400 may involve processor 212 receiving, via transceiver 216, a response message from the communication entity. Process 400 may proceed from 430 to 440.

At 440, process 400 may involve processor 212 determining, based on a second hash value in the response message, whether the communication entity is a network node of a genuine PLMN or a rogue cell faking to be genuine. Depending on a result of the determination, process 400 may proceed from 440 to 450 or 460.

At 450, process 400 may involve processor 212 behaving according to a reject cause in the response message responsive to the communication entity being deemed genuine.

At 460, process 400 may involve processor 212 ignoring the response message responsive to the communication entity being deemed fake.

In some implementations, in generating the first hash value, process 400 may involve processor 212 computing the first hash value over at least a portion of a PDU of a request using a SUCI concealment function.

In some implementations, in generating the first hash value, process 400 may involve processor 212 computing the first hash value over a local SUPI value.

In some implementations, in generating the first hash value, process 400 may involve processor 212 computing the first hash value using a parameter, an algorithm or both the parameter and the algorithm of a SUCI concealment function.

In some implementations, in determining based on the second hash value in the response message, process 400 may involve processor 212 comparing the first hash value and the second hash value to determine that the communication entity is genuine responsive to the second hash value being equal to the first hash value or that the communication entity is fake responsive to the second hash value being different from the first hash value.

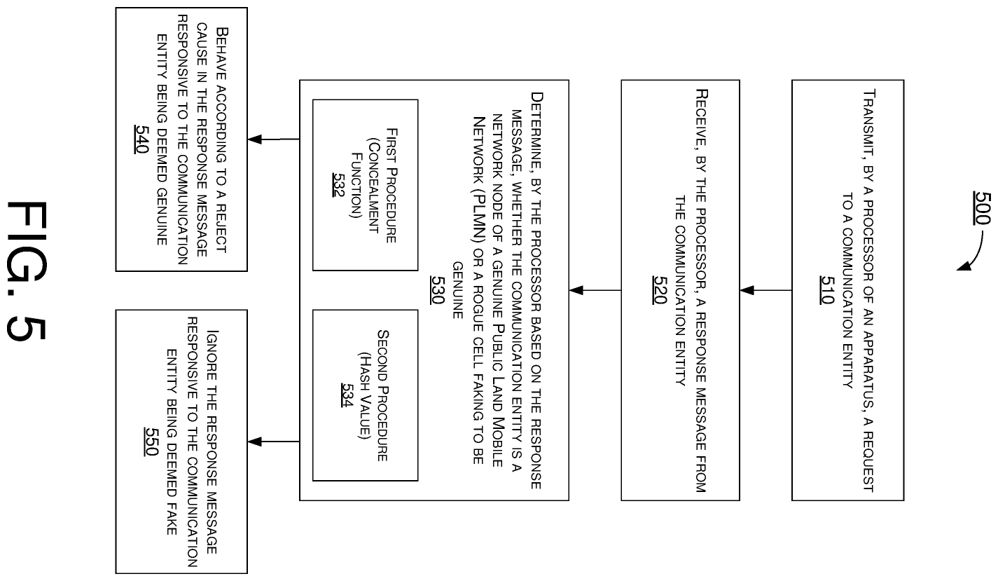

FIG. 5 illustrates an example process 500 in accordance with an implementation of the present disclosure. Process 500 may represent an aspect of implementing various proposed designs, concepts, schemes, systems and methods described above, whether partially or entirely, including network environment 100. More specifically, process 500 may represent an aspect of the proposed concepts and schemes pertaining to detection of rogue cells in 5G mobile communications. Process 500 may include one or more operations, actions, or functions as illustrated by one or more of blocks 510, 520, 530, 540 and 550 as well as sub-blocks 532 and 534. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 210 and apparatus 220 as well as any variations thereof. Solely for illustrative purposes and without limiting the scope, process 500 is described below in the context of apparatus 210 as a UE (e.g., UE 110) and apparatus 220 as a communication entity, whether as a network node or base station (e.g., network node 125) of a genuine PLMN (e.g., wireless network 120) or rogue cell 135. Process 500 may begin at block 510.

At 510, process 500 may involve processor 212 of apparatus 210 transmitting, via transceiver 216, a request to a communication entity (e.g., apparatus 220). Process 500 may proceed from 510 to 520.

At 520, process 500 may involve processor 212 receiving, via transceiver 216, a response message from the communication entity. Process 500 may proceed from 520 to 530.

At 530, process 500 may involve processor 212 determining, based on the response message, whether the communication entity is a network node of a genuine PLMN or a rogue cell faking to be genuine. In some implementations, in determining, process 500 may involve processor 212 determining by a first procedure (as represented by 532) using a concealment function, or a second procedure (as represented by 534) using a hash value. Depending on a result of the determination, process 500 may proceed from 530 to 540 or 550.

At 540, process 500 may involve processor 212 behaving according to a reject cause in the response message responsive to the communication entity being deemed genuine.

At 550, process 500 may involve processor 212 ignoring the response message responsive to the communication entity being deemed fake.

At 532, in determining by using the first procedure using the concealment function, process 500 may involve processor 212 performing various operations. For instance, process 500 may involve processor 212 generating the request such that the request contains an identity of apparatus 210 in a concealed format generated using the concealment function. Moreover, the response message may contain at least one portion of a de-concealed identity. Furthermore, in determining, process 500 may involve processor 212 comparing the at least one portion of the de-concealed identity to at least one corresponding portion of the identity of apparatus 210 to determine that the communication entity is genuine responsive to the at least one portion of the de-concealed identity being equal to the at least one corresponding portion of the identity of apparatus 210 or that the communication entity is fake responsive to the at least one portion of the de-concealed identity being different from the at least one corresponding portion of the identity of apparatus 210.

At 534, in determining by using the second procedure using the hash value as a first hash value, process 500 may involve processor 212 performing various operations in generating the first hash value. For instance, process 500 may involve processor 212 computing the first hash value over at least a portion of a PDU of the request using a SUCI concealment function. Additionally, process 500 may involve processor 212 either computing the first hash value over a local SUPI value or computing the first hash value using a parameter, an algorithm or both the parameter and the algorithm of the SUCI concealment function. The response message may contain a second hash value. In such cases, in determining, process 500 may involve processor 212 comparing the first hash value and the second hash value to determine that the communication entity is genuine responsive to the second hash value being equal to the first hash value or that the communication entity is fake responsive to the second hash value being different from the first hash value.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, at least a part of a request using a concealment function;
transmitting, by the processor, the request to a communication entity;
receiving, by the processor, a response message from the communication entity; and
determining, by the processor based on a parameter in the response message, whether the communication entity is a network node of a genuine Public Land Mobile Network (PLMN) or a rogue cell faking to be genuine.

2. The method of claim 1, wherein the generating of the at least a part of the request using the concealment function comprises generating the request containing an identity of the apparatus in a concealed format using the concealment function.

3. The method of claim 2, wherein the receiving of the response message comprises receiving the response message containing a de-concealed identity and optionally a reject cause.

4. The method of claim 3, wherein the determining based on the parameter in the response message comprises comparing the de-concealed identity to the identity of the apparatus to determine that the communication entity is genuine responsive to the de-concealed identity being equal to the identity of the apparatus or that the communication entity is fake responsive to the de-concealed identity being different from the identity of the apparatus.

5. The method of claim 3, wherein the determining based on the parameter in the response message comprises:
identifying a portion of the de-concealed identity; and
comparing the portion of the de-concealed identity to a corresponding portion of the identity of the apparatus to determine that the communication entity is genuine responsive to the portion of the de-concealed identity being equal to the corresponding portion of the identity of the apparatus or that the communication entity is fake responsive to the portion of the de-concealed identity being different from the corresponding portion of the identity of the apparatus.

6. The method of claim 2, wherein the receiving of the response message comprises receiving the response message containing a portion of a de-concealed identity.

7. The method of claim 6, wherein the determining based on the parameter in the response message comprises comparing the portion of the de-concealed identity to a corresponding portion of the identity of the apparatus to determine that the communication entity is genuine responsive to the portion of the de-concealed identity being equal to the corresponding portion of the identity of the apparatus or that the communication entity is fake responsive to the portion of the de-concealed identity being different from the corresponding portion of the identity of the apparatus.

8. The method of claim 1, wherein the generating of the request using the concealment function further comprises concealing a parameter or data using the concealment function such that the request contains the parameter or data in a concealed format.

9. The method of claim 8, wherein the receiving of the response message comprises receiving the response message containing de-concealed data.

10. The method of claim 9, wherein the determining based on the parameter in the response message comprises comparing the de-concealed data, or a portion of the de-concealed data, to the data or parameter sent in the request to determine that the communication entity is genuine responsive to the de-concealed data being equal to the data or parameter sent in the request or that the communication entity is fake responsive to the de-concealed data being different from the data or parameter sent in the request.

11. The method of claim 1, wherein the receiving of the response message comprises receiving the response message such that at least one portion of the response message is concealed.

12. The method of claim 11, wherein the determining based on the parameter in the response message comprises de-concealing, using the concealment function, the at least one portion of the response message that is concealed.

13. A method, comprising:
generating, by a processor of an apparatus, a first hash value and a request;
transmitting, by the processor, the request to a communication entity;
receiving, by the processor, a response message from the communication entity; and
determining, by the processor based on a second hash value in the response message, whether the communication entity is a network node of a genuine Public Land Mobile Network (PLMN) or a rogue cell faking to be genuine.

14. The method of claim 13, wherein the generating of the first hash value comprises computing the first hash value over at least a portion of a protocol data unit (PDU) of a request using a Subscription Concealed Identifier (SUCI) concealment function.

15. The method of claim 13, wherein the generating of the first hash value comprises computing the first hash value over a local Subscriber Permanent Identifier (SUPI) value.

16. The method of claim 13, wherein the generating of the first hash value comprises computing the first hash value using a parameter, an algorithm or both the parameter and the algorithm of a Subscription Concealed Identifier (SUCI) concealment function.

17. The method of claim 13, wherein the determining based on the second hash value in the response message comprises comparing the first hash value and the second hash value to determine that the communication entity is genuine responsive to the second hash value being equal to the first hash value or that the communication entity is fake responsive to the second hash value being different from the first hash value.

18. A method, comprising:
transmitting, by a processor of an apparatus, a request to a communication entity;
receiving, by the processor, a response message from the communication entity; and
determining, by the processor based on the response message, whether the communication entity is a network node of a genuine Public Land Mobile Network (PLMN) or a rogue cell faking to be genuine,
wherein the determining comprises determining by a first procedure using a concealment function or a second procedure using a hash value.

19. The method of claim 18, wherein the determining comprises determining by using the first procedure using the concealment function, and wherein:
the request contains an identity of the apparatus in a concealed format generated using the concealment function;
the response message contains at least one portion of a de-concealed identity; and
the determining comprises comparing the at least one portion of the de-concealed identity to at least one corresponding portion of the identity of the apparatus to determine that the communication entity is genuine responsive to the at least one portion of the de-concealed identity being equal to the at least one corresponding portion of the identity of the apparatus or that the communication entity is fake responsive to the at least one portion of the de-concealed identity being different from the at least one corresponding portion of the identity of the apparatus.

20. The method of claim 18, wherein the determining comprises determining by using the second procedure using the hash value as a first hash value, and wherein:
the first hash value is generated by:
computing the first hash value over at least a portion of a protocol data unit (PDU) of the request using a Subscription Concealed Identifier (SUCI) concealment function;
computing the first hash value over a local Subscriber Permanent Identifier (SUPI) value; or
computing the first hash value using a parameter, an algorithm or both the parameter and the algorithm of the SUCI concealment function;
the response message contains a second hash value; and
the determining comprises comparing the first hash value and the second hash value to determine that the communication entity is genuine responsive to the second hash value being equal to the first hash value or that the communication entity is fake responsive to the second hash value being different from the first hash value.
